(19) United States
(12) Patent Application Publication
(10) Pub. No.: US 2022/0188509 A1
(43) Pub. Date: Jun. 16, 2022

(54) METHOD FOR EXTRACTING CONTENT FROM DOCUMENT, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Kai Zeng, Beijing (CN); Hua Lu, Beijing (CN)

(73) Assignee: BEIJING BAIDU NETCOM SCIENCE TECHNOLOGY CO., LTD., Beijing (CN)

(21) Appl. No.: 17/456,765

(22) Filed: Nov. 29, 2021

(30) Foreign Application Priority Data
Dec. 16, 2020 (CN) 202011487916.6

(51) Int. Cl. G06F 40/205; G06F 16/93; G06F 16/31; G06F 16/33

(52) U.S. Cl. CPC G06F 40/205; G06F 16/3331; G06F 16/322; G06F 16/93

(57) ABSTRACT

The disclosure provides a method and an apparatus for extracting content from a document, an electronic device, and a storage medium, which relates to the field of artificial intelligence (AI) technologies such as natural language processing (NLP), deep learning (DL), knowledge graph (KG). The detailed implementation scheme is: obtaining the document; performing anchor search on the document to obtain anchor information corresponding to the document; determining region information of content to be extracted based on the anchor information; and extracting the content to be extracted from the document based on the region information.

### CROSS-REFERENCE TO RELATED APPLICATION

This application is based on and claims priority to Chinese Patent Application No. 202011487916.6 filed on Dec. 16, 2020, the content of which is hereby incorporated by reference in its entirety into this disclosure.

### TECHNICAL FIELD

The disclosure relates to the field of computer technologies, specifically to the field of artificial intelligence (AI) technologies such as natural language processing (NLP), deep learning (DL), knowledge graph (KG), and particularly to a method and an apparatus for extracting content from a document, an electronic device, and a storage medium.

### BACKGROUND

Artificial intelligence (AI) is a subject that learns simulating certain thinking processes and intelligent behaviors (such as learning, reasoning, thinking, planning) of human beings through computers, which covers hardware-level technologies and software-level technologies. The AI hardware technologies generally include technologies such as sensors, dedicated AI chips, cloud computing, distributed storage, big data processing; the AI software technologies mainly include computer vision technology, speech recognition technology, natural language processing (NLP) technology and machine learning (ML)/deep learning (DL), big data processing technology, knowledge graph (KG) technology.

A document generally includes one or more key-value pairs, tables, and the like. Document extraction means recognizing content in the document, to obtain actual content corresponding to required one or more key-value pairs and tables.

### SUMMARY

According to a first aspect, a method for extracting content from a document is provided and includes: obtaining the document; performing anchor search on the document to obtain anchor information corresponding to the document; determining region information of content to be extracted based on the anchor information; and extracting the content to be extracted from the document based on the region information.

According to a second aspect, an electronic device is provided, and includes: at least one processor; and a memory communicating with the at least one processor; in which, the memory is configured to store instructions executable by the at least one processor, and when the instructions are executed by the at least one processor, the at least one processor performs the method for extracting content from the document according to the embodiments of the disclosure.

According to a third aspect, a non-transitory computer-readable storage medium storing computer instructions is provided, in which the computer instructions are configured to cause a computer to perform the method for extracting content from the document according to the embodiments of the disclosure.

It should be understood that the content described in this section is not intended to identify the key or important features of the embodiments of the disclosure, nor is it intended to limit the scope of the disclosure. Additional features of the disclosure will be easily understood by the following description.

### BRIEF DESCRIPTION OF THE DRAWINGS

The accompanying drawings are used to understand the solution better, and do not constitute a limitation on the application, in which:

FIG. 1 is a schematic diagram illustrating a first embodiment of the disclosure.

FIG. 2 is a schematic diagram illustrating a structure of a spatial index search tree in some embodiments of the disclosure.

FIG. 3 is a schematic diagram illustrating a second embodiment of the disclosure.

FIG. 4 is a schematic diagram illustrating a third embodiment of the disclosure.

FIG. 5 is a schematic diagram illustrating a fourth embodiment of the disclosure.

FIG. 6 is a block diagram illustrating an electronic device for implementing a method for extracting content from a document in some embodiments of the disclosure.

### DETAILED DESCRIPTION

The following describes the exemplary embodiments of the disclosure with reference to the accompanying drawings, which includes various details of the embodiments of the disclosure to facilitate understanding and shall be considered merely exemplary. Therefore, those of ordinary skill in the art should recognize that various changes and modifications may be made to the embodiments described herein without departing from the scope and spirit of the disclosure. For clarity and conciseness, descriptions of well-known functions and structures are omitted in the following description.

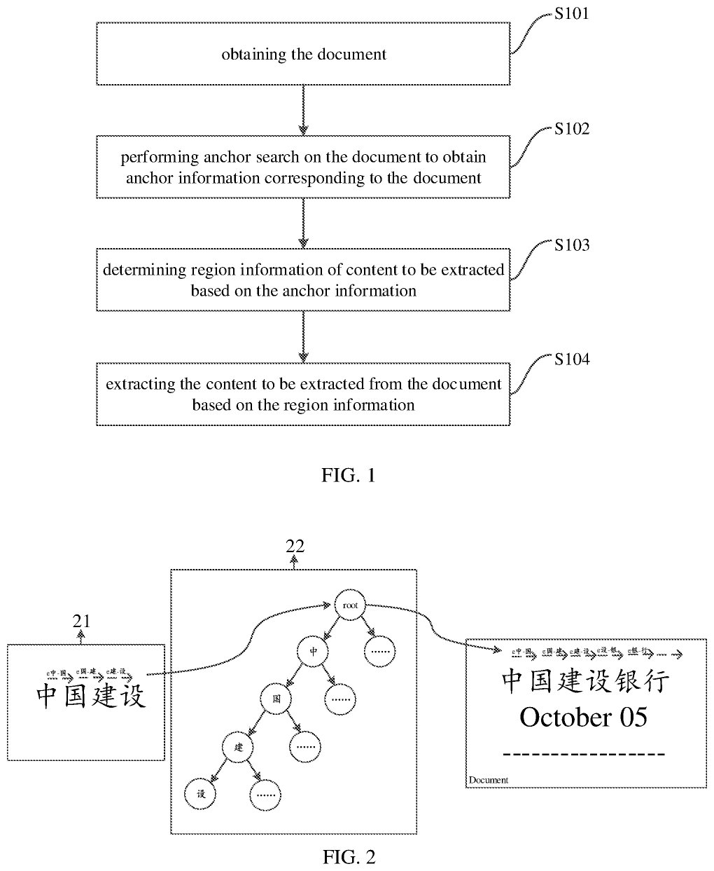

FIG. 1 is a schematic diagram illustrating a first embodiment of the disclosure.

It should be noted that, an executive body of a method for extracting content from a document in some embodiments is an apparatus for extracting content from a document in some embodiments. The apparatus may be implemented by means of software and/or hardware. The apparatus may be configured in an electronic device. The electronic device may include but be not limited to a terminal, a server side, etc.

The embodiments of the disclosure relate to the field of artificial intelligence (AI) technologies such as natural language processing (NLP), deep learning (DL), and knowledge graph (KG).

Artificial Intelligence, abbreviated as AI, is a new technical science that studies and develops theories, methods, technologies, and application systems for simulating, extending, and expanding human intelligence.

The deep learning (DL) learns inherent law and representation hierarchy of sample data, and information obtained in the learning process is of great help in interpretation of data such as words, images and sound. The final goal of DL is that the machine may have analytic learning ability like human beings, which may recognize data such as words, images, sound.

The natural language processing (NLP) studies all kinds of theories and methods that may achieve effective communication between human and computer through natural language.

The knowledge graph (KG) is a modern theory that combines theories and methods of applied mathematics, graphics, information visualization technology, information science, and other disciplines, with metrological citation analysis, co-occurrence analysis and other methods, and uses visual graphs to vividly display the core structure, development history, frontiers, and overall knowledge structure of the discipline to achieve multi-disciplinary integration.

As illustrated in FIG. 1, the method for extracting content from the document includes the following.

At S101, the document is obtained.

The document is any document whose content is to be extracted, which may include one or more key-value pairs, tables, pictures, texts, and the like, which will not be limited herein.

In some embodiments of the disclosure, a text input interface may be provided via an electronic device to receive a piece of text input by the user, and a standardized document may be formed based on the piece of text, or a speech segment recorded by the user may be parsed to convert the speech segment into the corresponding standardized document, which will not be limited herein.

At S102, anchor search is performed on the document to obtain anchor information corresponding to the document.

After the document is obtained, the anchor search is performed on the document to obtain the anchor information corresponding to the document.

An anchor may be for example a key in the key-value pair in the document, for example, the key-value pair may be [symbol] (Chinese characters, which means bank name—Industrial and Commercial Bank of China), the key is “ [symbol] ” (Chinese characters, which means bank name), and the value is “ [symbol] ” (Chinese characters, which means Industrial and Commercial Bank of China); the key-value pair, for another example, may be a header and table content corresponding to the header, the key may be the header, and the value may be the corresponding table content, which will not be limited herein.

The anchors in some embodiments of the disclosure may be the keys in the above examples, in which the key “ [symbol] ” may be referred to as a character key, and the key in the header form may be referred to as a header key, and the character key and the header key may identify the concept of the key described in some embodiments of the disclosure, which will not be limited herein.

Thus, the anchor search is performed on the document, specifically to search the character key and the header key in the document. That is, when the content is extracted from the document in the disclosure, the character key and the header key are searched in the document first, and content extraction is assisted based on the searched character key and header key, rather than all the actual content in the whole document is searched, which may effectively enhance extraction efficiency.

In some embodiments, the anchor search is performed on the document to obtain the anchor information corresponding to the document, which may be the following. The anchor search may be performed on the document by adopting a pregenerated spatial index search tree, to obtain the anchor information corresponding to the document. Therefore, the disclosure may effectively enhance search efficiency and guarantee search accuracy.

The spatial index search tree may be pregenerated. For example, a large number of sample documents (also referred to template documents) may be obtained, to recognize content of each sample document, select the content that needs to be extracted from each sample document, and determine a reference key (a key pre-labeled in the sample document may be referred to as the reference key) corresponding to the content that needs to be extracted, and a reference value corresponding to the reference key (a value corresponding to the pre-labeled reference key in the sample document may be referred to as the reference value, and illustrations of the reference key and the reference value may be referred as the above, which will not be repeated herein). When the reference key and the reference value corresponding to each sample document are obtained, the reference key may be taken as the reference anchor and one or more characters of each reference anchor may be taken as the nodes, and the edge may be constructed between characters search-related to each other. The spatial index search tree may be formed based on one or more characters of each reference anchor and the corresponding edges.

The above process of constructing the spatial index search tree is a process of manual labeling. For example, the process of manual labeling refers to labeling structured content expected to be extracted on each sample document by a labeling tool, such as, it may be implemented through drawing a rectangle frame+inputting a tag: for a character key-value pair (a character key—a value corresponding to the character key), it may select the whole content of the character key with a box and a tag of k1 may be input; select the whole content of the corresponding value with a box and a tag of v1 may be input; for a second character key-value pair, the above actions may be repeated, and the difference is the input tags transformed to k2 and v2, and the same number represents the one-to-one matching relationship between the character key and the corresponding value.

For another example, for a key in the form of a header (a header key—a value corresponding to the header key): it may select the whole content of a header cell corresponding to the header key with a box and a tag of h1 may be input; select the whole content of the remaining cells in the row and/or column corresponding to the header key with a box and a tag of v1 may be input; for labeling of a second header cell in the table, the above actions may be repeated, and the difference is that the input tags transformed to h2 and v2, and the same number represents the one-to-one matching relationship between the header and the row and/or column.

When the character key and the header key are labeled in the sample document, characters in the character key and the header key may be taken as nodes to construct the spatial index search tree.

For example, for the same type of documents, the character key and the header key manually labeled may be regarded as fixed, and the corresponding content may vary. Therefore, the character key and the header key may be taken as the reference node to construct the spatial index search tree based on characters in the character key and the header key, so as to perform the anchor search in the actual document based on the spatial index search tree subsequently to obtain the character key and the header key in the document by search.

Optionally, in some embodiments, the spatial index search tree includes a plurality of nodes and a plurality of edges, in which each of the plurality of nodes represents a character in a reference anchor, and each of the plurality of edges represents a correlation vector between characters corresponding to nodes connected by the corresponding edge.

For example, the spatial index search tree may be defined as a prefix tree. Nodes on the tree represent characters in reference anchors. A path from a root node to a leaf node in the tree represents the reference anchor. The reference keys with the same prefix may share a partial path starting from the root node on the spatial index search tree. An edge between nodes on the tree represents a vector from the previous character to the latter character (the vector may describe a correlation between characters. Therefore, the vector may be referred to as a correlation vector).

In some embodiments, the spatial index search tree is constructed as above, so that the spatial index search tree includes the plurality of nodes and the plurality of edges, in which each of the plurality of nodes represents the character in the reference anchor, and each of the plurality of edges represents the correlation vector between characters corresponding to the nodes connected by the corresponding edge. Furthermore, correlation vectors may be normalized based on the dimension of characters. The labeling is simple, thus reducing amount of labeled data, effectively reducing consumption of hardware and software resources needed for the document extraction, and avoiding the impact on content extraction caused by size scaling in the process of document typesetting. When the spatial index search tree is applied to the actual process of extracting content from the document, it has good universality, which improves the flexibility of extracting content from the document.

Referring to FIG. 2, FIG. 2 is a schematic diagram illustrating a structure of a spatial index search tree in some embodiments of the disclosure. A module 21 in FIG. 2 represents characters labeled in the sample document and correlation vectors may be configured between each character, so that each character is taken as the node and the correlation vector between correlation characters is taken as the edge to construct the spatial index search tree (a module 22 in FIG. 2). In the actual application, in combination with the spatial index search tree in FIG. 2, the content in the document is matched character by character to recognize and obtain the anchor in the document. In detail, in the module 21 in FIG. 2, Chinese characters “ [symbol] ” mean China Construction; “e [symbol] ” mean e China-Nation; “e [symbol] ” mean e Nation-Constructing; “e [symbol] ” mean e Constructing-Establishing; in the module 22 in FIG. 2, a Chinese character “ [symbol] ” means China; a Chinese character “ [symbol] ” means Nation; a Chinese character “ [symbol] ” means Constructing; a Chinese character “ [symbol] ” means Establishing; in the module 23 in FIG. 2, Chinese characters “ [symbol] ” mean China Construction Bank; e “ [symbol] ” mean e Establishing-Bank; e “ [symbol] ” mean e Bank-Bank.

In some embodiments, the reference anchor includes the reference key, so that the anchor search is performed on the document by the pregenerated spatial index search tree to obtain the anchor information corresponding to the document. Each character in the document may be searched by the spatial index search tree to obtain a target key matching the reference key; relative layout information of the reference key and a reference value of the reference key in the sample document may be determined; the target key is taken as the anchor corresponding to the document obtained by search, and the relative layout information is taken as anchor information corresponding to the anchor.

That is, in some embodiments of the disclosure, the reference key may further be configured as the reference anchor. Since the reference key and the reference value are derived from the corresponding key-value pairs in the sample document, the reference key and the reference value are mapped to the sample document with the relative layout information, such as the reference key and the reference value are mapped to the sample document with the relative layout position, size information, which may be referred to as the relative layout information.

It is understandable that, since the reference key and the reference value are pre-labeled based on a large number of sample documents, and the reference key and the reference value have the relative layout information correspondingly mapped to the sample document, in some embodiments of the disclosure, each character in the document is searched by the spatial index search tree to obtain the target key matching the reference key by search from the document (the key matching the reference key in the document may be referred to as the target key); the relative layout information of the reference key and the reference value in the sample document are determined; the target key is taken as the anchor corresponding to the document obtained by search, and the relative layout information is taken as the anchor information corresponding to the anchor.

The above relative layout information and target key may be configured to assist in extracting subsequently content from the document. For example, the spatial index search tree may be configured to search from each character in the document along a relevance vector of the next character recorded. When the next character may be found along the correlation vector, the search continues along the correlation vector of the another next character until a complete target key (a character key or a header) is found according to the correlation vector between each character, and the target key is taken as the searched anchor, and the corresponding reference key and the relative layout information corresponding to the reference value are recorded as the anchor information of the anchor for the next extraction.

When each target key is searched as the starting point, an anchor sequence may be obtained (the anchor sequence may include a plurality of anchors), and anchor information of each anchor in the anchor sequence may be configured to guide the next content extraction process.

Since the anchor search is performed starting from each character by the spatial index search tree, each anchor may be considered to be independent with each other, so that changes in the document layout caused by various factors do not affect the anchor search by the spatial index search tree. In addition, when searching, each anchor may also support a search method of case matching, to avoid the impact of the case of English characters on the document layout, so that the absolute position, zoom size, rotation angle, and English character size of the document on the page do not affect extraction effect, which guarantees the flexibility of recognizing anchors, and further expands the application scope of the method of extracting content from the document.

In some embodiments, the number of reference anchors is multiple or there are reference anchors. The target key matching the reference key may be obtained from the document, which may be as follows. A matching path may be determined based on the correlation vectors, which includes at least two reference anchors, and each reference anchor on the matching path may be traversed based on the correlation vectors; and a target key matching each of the reference keys is obtained by searching from the document.

That is, in the embodiments of the disclosure, another method for searching anchors from the document is further provided. A matching path may be determined based on each correlation vector (the matching path may include edges with correlation vectors) first, and a target key in the document is searched directly based on characters of each reference anchor (the reference anchor, i.e. the reference key) on the matching path as a searched anchor, which may reduce data size of labeled reference anchors for search and enhance search efficiency.

At S103, region information of content to be extracted is determined based on the anchor information.

In the above, the target key is taken as the searched anchor, and the relative layout information corresponding to the reference key and the corresponding reference value (the relative layout information may also be labeled together when the reference key and the reference value are pre-labeled, which will not limited here) is recorded as the anchor information of the anchor, and the region information of the content to be extracted may be directly determined based on the target key and the relative layout information.

The content expected to be extracted in the document may be referred to as the content to be extracted.

For example, the target key and the relative layout information may be input to a pre-trained model to determine the region information of the content to be extracted based on the output of the model, or any other possible ways may be configured to determine the region information of the content to be extracted based on the anchor information, for example, as a method of engineering, a method of mathematical operation, which is not limited here.

At S104, the content to be extracted is extracted from the document based on the region information.

When the region information of the content to be extracted is determined, content recognition may be performed on the document. The content mapped to the region covered by the region information in the content recognized is taken as the content to be extracted, which will not be limited herein.

In some embodiments, the document is obtained, the anchor search is performed on the document to obtain the anchor information corresponding to the document, the region information of the content to be extracted is determined based on the anchor information, and the content to be extracted is extracted from the document based on the region information, which effectively enhances the accuracy, efficiency and effect of extracting content from the document.

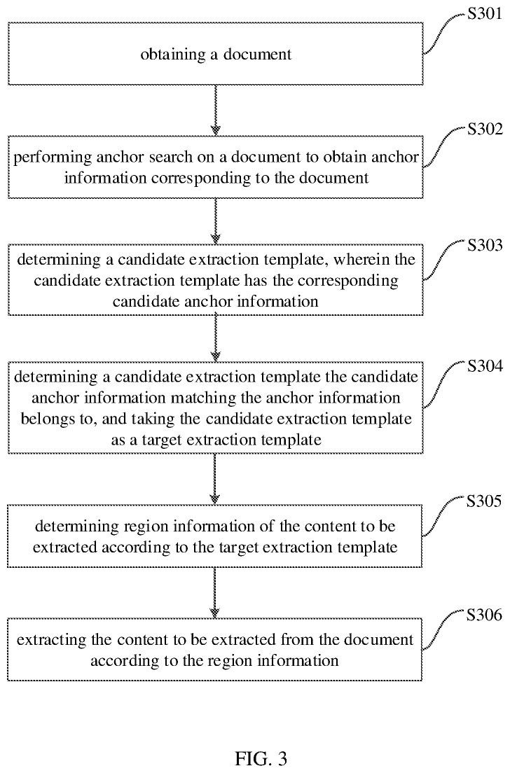

FIG. 3 is a diagram illustrating a second embodiment of the disclosure.

As illustrated in FIG. 3, the method for extracting content from the document includes the following.

At S301, the document is obtained.

At S302, anchor search is performed on the document to obtain anchor information corresponding to the document.

The explanation of S301-S302 may see the above embodiments, which will not be repeated herein.

At S303, candidate extraction templates are determined, in which the candidate extraction templates each has corresponding candidate anchor information.

The candidate extraction template may be pre-labeled, and the candidate extraction template may include extraction processing logic. That is, the candidate extraction template may be called, so that the content to be extracted is extracted from the document based on the extraction processing logic contained in the candidate extraction template.

Anchor information corresponding to the candidate extraction template may be referred to as the candidate anchor information, and the candidate extraction template may be configured to extract the content from the document whose anchor information matching the candidate anchor information.

The number of the candidate extraction templates may be multiple. In some embodiments, a target extraction template matching the searched anchor information is selected from the plurality of candidate extraction templates.

At S304, a candidate extraction template whose candidate anchor information matching the anchor information is determined, and the determined candidate extraction template is taken as a target extraction template.

When a plurality of candidate extraction templates and candidate anchor information corresponding to each of the plurality of candidate extraction templates are determined, a target extraction template matching the searched anchor information is selected from the plurality of candidate extraction templates.

The candidate extraction template whose candidate anchor information matching the anchor information may be referred to as the target extraction template. Since the candidate anchor information of the target extraction template matches the anchor information searched from the document, it may achieve automatic management of the candidate extraction templates and automatic selection of the target extraction template with the best extraction effect.

In some embodiments, determining the candidate extraction template whose candidate anchor information matching the anchor information may include the following. The anchor information and the candidate anchor information may be input to a pre-trained graph model to obtain the determined candidate extraction template output by the graph model.

The graph model may be a graph model in deep learning, or a graph model of any other possible architectural form in the field of artificial intelligence technologies, which will not be limited herein.

The graph model adopted in the embodiments is a graphical representation of probability distribution, in which a graph includes nodes and their links. In the probability graph model, each node represents a random variable or a set of random variables, and a link represents a probability relationship between these variables. In this way, the graph model describes that joint probability distribution on all random variables may be decomposed into a multiplication of a set of factors, and each of the factors only depends on a subset of the random variables.

For example, the anchor information and the candidate anchor information may be input to the pre-trained graph model first. A graph G (V, E) with anchor information as a node and a link between two anchor information as an edge is established based on the pre-trained graph model, in which V represents a node and E represents an edge. According to the same method, all candidate extraction templates may further be abstracted as graphs. A similarity of the document Gᵢ(V, E) and the candidate extraction template Gⱼ(V, E) may be measured based on the pre-trained graph model (i represents the number of anchors searched in the document, j represents the number of candidate anchors in each candidate extraction template), and the candidate extraction template with the greatest similarity is determined as the target extraction template.

The formula that measures the similarity of the document Gᵢ(V, E) and the candidate extraction template Gⱼ(V, E) based on the pre-trained graph model may be any possible similarity calculation formula in the related art, which will not be limited herein.

In some embodiments, since a graph similarity matching algorithm is adopted, the similarity between the document and the candidate extraction template may be measured. Furthermore, for the anchors with the same text content, a subgraph centering on the conflict anchor may be constructed according to the difference of the anchor in the layout of the document, and each conflicting anchor is distinguished according to the graph similarity algorithm, thereby allowing to exist a plurality of same keys and achieving distinguished detection of conflict anchors.

When the candidate extraction templates are determined, the candidate extraction template whose candidate anchor information matching the anchor information is determined, and the determined candidate extraction template is taken as the target extraction template, the content to be extracted may be extracted from the document directly based on the target extraction template, so as to achieve extracting the content from the document by the target extraction template. The candidate anchor of the target extraction template and the anchor layout in the document have a relatively matching similarity, thereby effectively improving the extraction accuracy.

At S305, region information of content to be extracted is determined based on the target extraction template.

The region information, for example, the position, size and other information of the region occupied by the content to be extracted in the document, such as, region A occupied by the content to be extracted, may be relative position coordinates, a length-to-width ratio, etc. relative to the whole region of the document.

In some embodiments, when the region information of the content to be extracted is determined based on the target extraction template, benchmark layout information in the target extraction template corresponding to the target key may be determined; and the region information is determined based on the benchmark layout information in combination with the relative layout information.

The target key is the anchor searched from the document, and the searched anchor has a high similarity with the candidate anchor of the target extraction template. Therefore, in the embodiments, in order to directly and quickly extract the content from the document based on the target extraction template in the extraction process, the anchor searched from the document may match the target extraction template, and the layout position and size in the target extraction template corresponding to the target key searched in the document as the benchmark layout information, and the region information is determined in combination with the relative layout information (the a relative layout position, and size information, etc. of the reference key and the reference value mapped to the sample document).

For example, the benchmark layout may be added to the relative layout information to calculate the position and size of the region occupied by the content to be extracted in the document, which is not limited herein.

At S306, the content to be extracted is extracted from the document based on the region information.

For example, when the target extraction template is determined, each target key has a corresponding matching reference key, and the reference value and the relative layout information between the reference key and its corresponding reference value are pre-labeled for the reference key. Therefore, based on the benchmark layout of the anchor in the target extraction template in combination with the relative layout information between the reference key and the corresponding reference value, the region information of the content to be extracted (the size and position of the region occupied by the content) may be calculated in the document, and the content to be extracted is extracted from the region described by the region information (such as a key-value pair and a header in the region described by the region information or the actual content of the row or column structure).

Since the benchmark layout information in the target extraction template corresponding to the target key is determined, and the region information is determined based on the benchmark layout information in combination with the relative layout information, it may assist subsequent direct extraction of the content to be extracted in the region described by the region information, which is simple to implement, with better applicability and practicality, and enhanced extraction efficiency and accuracy.

In some embodiments of the disclosure, when the number of candidate extraction templates is multiple, multiple candidate extraction templates may be combined and spliced, or the candidate extraction templates may be split based on the actual application requirements. In some embodiments of the disclosure, when the template is matched and extracted, partial template matching may be supported. Therefore, it has better extraction flexibility.

In some embodiments, the candidate anchor information of the target extraction template matches the anchor information searched from the document, so as to achieve automatic management of the candidate extraction templates and automatic selection of the target extraction template with the best extraction effect. Since the graph similarity matching algorithm is adopted, the similarity between the document and the candidate extraction template may be measured. Furthermore, for the anchors with the same text content, a subgraph centering on the conflict anchor may be constructed according to the difference of the anchor in the layout of the document, and each conflicting anchor is distinguished according to the graph similarity algorithm, thereby allowing to exist a plurality of same keys and achieving distinguished detection of conflict anchors. When the candidate extraction templates are determined, the candidate extraction template whose candidate anchor information matching the anchor information is determined, and the determined candidate extraction template is taken as the target extraction template, the content to be extracted may be extracted from the document directly based on the target extraction template, so as to achieve extracting the content from the document by the target extraction template. The candidate anchor of the target extraction template and the anchor layout in the document have a relatively matching similarity, thereby effectively improving the extraction accuracy.

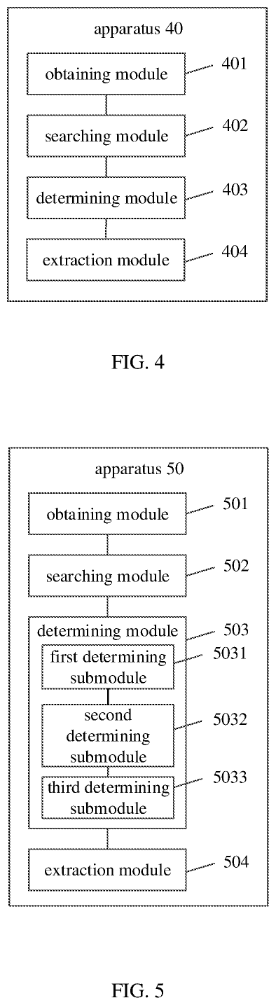

FIG. 4 is a diagram illustrating a third embodiment of the disclosure.

As illustrated in FIG. 4, the apparatus 40 for extracting content from the document includes: an obtaining module 401, a searching module 402, a determining module 403, and an extraction module 404.

The obtaining module 401 is configured to obtain the document.

The searching module 402 is configured to perform anchor search on the document to obtain anchor information corresponding to the document.

The determining module 403 is configured to determine region information of content to be extracted based on the anchor information.

The extraction module 404 is configured to extract the content to be extracted from the document based on the region information.

In some embodiments, the searching module 402 is configured to: perform the anchor search on the document by a pregenerated spatial index search tree to obtain the anchor information corresponding to the document.

In some embodiments, the spatial index search tree includes a plurality of nodes and a plurality of edges, in which, each of the plurality of nodes represents a character in a reference anchor, and each of the plurality of edges represents a correlation vector between characters corresponding to nodes connected by the corresponding edge.

In some embodiments, the reference anchor is a reference key.

The searching module 402 is configured to: obtain a target key matching the reference key from the document through searching each character in the document by the pregenerated spatial index search tree; determine relative layout information of the reference key and a reference value of the reference key in a sample document; take the target key as an obtained anchor corresponding to the document, and the relative layout information as anchor information corresponding to the obtained anchor.

In some embodiments, there are reference anchors, and the searching module 402 is configured to: determine a matching path based on the correlation vectors, in which the matching path comprises at least two reference anchors; traverse each reference anchor on the matching path based on the correlation vectors; and obtain a target key matching each of the reference keys by searching from the document.

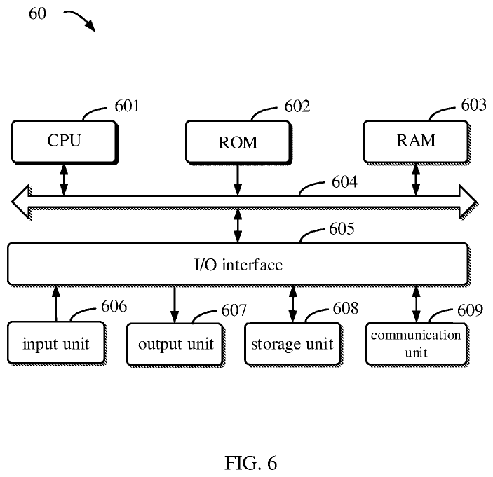

In some embodiments of the disclosure, as illustrated in FIG. 5, FIG. 5 is a diagram illustrating a fourth embodiment of the disclosure. The apparatus 50 for extracting the content from the document includes an obtaining module 501, a searching module 502, a determining module 503, and an extraction module 504, in which the determining module 503 includes: a first determining submodule 5031, a second determining submodule 5032, and a third determining submodule 5033.

The first determining submodule 5031 is configured to determine candidate extraction templates, in which the candidate extraction templates each has corresponding candidate anchor information.

The second determining submodule 5032 is configured to determine a candidate extraction template whose candidate anchor information matching the anchor information, and take the determined candidate extraction template as a target extraction template.

The third determining submodule 5033 is configured to determine the region information of the content to be extracted based on the target extraction template.

In some embodiments, the third determining submodule 5033 is configured to: determine benchmark layout information in the target extraction template corresponding to the target key; and determine the region information based on the benchmark layout information in combination with the relative layout information.

In some embodiments, the second determining submodule 5032 is configured to: input the anchor information and the candidate anchor information to a pre-trained graph model, to obtain the determined candidate extraction template output by the graph model.

It is understandable that, the apparatus 50 for extracting content from the document in FIG. 5 of this embodiment and the apparatus 40 for extracting content from the document in the above embodiment, the obtaining module 501 and the obtaining module 401 in the above embodiment, the searching module 502 and the searching module 402 in the above embodiment, the determining module 503 and the determining module 403 in the above embodiment, the extraction module 504 and the extraction module 404 in the above embodiment, have the same functions and structures.

It needs to be noted that the foregoing explanation of the method for extracting content from the document also applies to an apparatus for extracting content from a document in the embodiments, which will not be repeated here.

In the embodiments, the document is obtained, the anchor search is performed on the document to obtain the anchor information corresponding to the document, the region information of the content to be extracted is determined based on the anchor information, and the content to be extracted is extracted from the document based on the region information, which effectively enhances the accuracy, efficiency and effect of extracting content from the document.

In the embodiment of the disclosure, an electronic device, a readable storage medium and a computer program product are further provided according to embodiments of the disclosure

FIG. 6 is a block diagram illustrating an electronic device configured to implement a method for extracting content from a document in embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 6, the device 600 includes a computing unit 601. The computing unit 601 may execute various appropriate actions and processes according to computer program instructions stored in a read only memory (ROM) 602 or computer program instructions loaded to a random access memory (RAM) 603 from a storage unit 608. The RAM 603 may also store various programs and date required. The CPU 601, the ROM 602, and the RAM 603 may be connected to each other via a bus 604. An input/output (I/O) interface 605 is also connected to the bus 604.

A plurality of components in the device 600 are connected to the I/O interface 605, including: an input unit 606 such as a keyboard, a mouse; an output unit 607 such as various types of displays, loudspeakers; a storage unit 608 such as a magnetic disk, an optical disk; and a communication unit 609, such as a network card, a modem, a wireless communication transceiver. The communication unit 609 allows the device 600 to exchange information/data with other devices over a computer network such as the Internet and/or various telecommunication networks.

The computing unit 601 may be various general-purpose and/or special-purpose processing components having processing and computing capabilities. Some examples of the computing unit 601 include, but are not limited to, a central processing unit (CPU), a graphics processing unit (GPU), various dedicated artificial intelligence (AI) computing chips, various computing units running machine learning model algorithms, a digital signal processor (DSP), and any suitable processor, controller, microcontroller, etc. The computing unit 601 executes the above-mentioned methods and processes, such as the method.

For example, in some implementations, the method may be implemented as computer software programs. The computer software programs are tangibly contained a machine readable medium, such as the storage unit 608. In some embodiments, a part or all of the computer programs may be loaded and/or installed on the device 600 through the ROM 602 and/or the communication unit 609. When the computer programs are loaded to the RAM 603 and are executed by the computing unit 601, one or more blocks of the method described above may be executed. Alternatively, in other embodiments, the computing unit 601 may be configured to execute the method in other appropriate ways (such as, by means of hardware).

The functions described herein may be executed at least partially by one or more hardware logic components. For example, without not limitation, exemplary types of hardware logic components that may be used include: a field programmable gate array (FPGA), an application specific integrated circuit (ASIC), an application specific standard product (ASSP), a system on chip (SOC), a complex programmable logic device (CPLD) and the like. The various implementation modes may include: being implemented in one or more computer programs, and the one or more computer programs may be executed and/or interpreted on a programmable system including at least one programmable processor, and the programmable processor may be a dedicated or a general-purpose programmable processor that may receive data and instructions from a storage system, at least one input apparatus, and at least one output apparatus, and transmit the data and instructions to the storage system, the at least one input apparatus, and the at least one output apparatus.

Program codes for implementing the method of the present disclosure may be written in any combination of one or more programming languages. These program codes may be provided to a processor or a controller of a general purpose computer, a special purpose computer or other programmable data processing device, such that the functions/operations specified in the flowcharts and/or the block diagrams are implemented when these program codes are executed by the processor or the controller. These program codes may execute entirely on a machine, partly on a machine, partially on the machine as a stand-alone software package and partially on a remote machine, or entirely on a remote machine or entirely on a server.

In the context of the present disclosure, the machine-readable medium may be a tangible medium that may contain or store a program to be used by or in connection with an instruction execution system, apparatus, or device. The machine-readable medium may be a machine-readable signal medium or a machine-readable storage medium. The machine-readable medium may include, but not limit to, an electronic, magnetic, optical, electromagnetic, infrared, or semiconductor system, apparatus, or device, or any suitable combination of the foregoing. More specific examples of the machine-readable storage medium may include electrical connections based on one or more wires, a portable computer disk, a hard disk, a RAM, a ROM, an erasable programmable read-only memory (EPROM or flash memory), an optical fiber, a portable compact disk read-only memory (CD-ROM), an optical storage, a magnetic storage device, or any suitable combination of the foregoing.

In order to provide interaction with a user, the systems and technologies described herein may be implemented on a computer having a display device (e.g., a Cathode Ray Tube (CRT) or a Liquid

Crystal Display (LCD) monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or include such background components, intermediate computing components, or any combination of front-end components. The components of the system may be interconnected by any form or medium of digital data communication (egg, a communication network). Examples of communication networks include: local region network (LAN), wide region network (WAN), and the Internet.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system to solve management difficulty and weak business scalability defects of traditional physical hosts and Virtual Private Server (VPS) services.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of this application shall be included in the protection scope of this application.

1. A method for extracting content from a document, comprising:
obtaining the document;
performing anchor search on the document to obtain anchor information corresponding to the document;
determining region information of content to be extracted based on the anchor information; and
extracting the content to be extracted from the document based on the region information.

2. The method of claim 1, wherein, performing the anchor search on the document to obtain the anchor information corresponding to the document, comprises:
performing the anchor search on the document by a pregenerated spatial index search tree to obtain the anchor information corresponding to the document.

3. The method of claim 2, wherein, the spatial index search tree comprises a plurality of nodes and a plurality of edges, in which, each of the plurality of nodes represents a character in a reference anchor, and each of the plurality of edges represents a correlation vector between characters corresponding to nodes connected by the corresponding edge.

4. The method of claim 3, wherein, the reference anchor is a reference key,
wherein, performing the anchor search on the document by the pregenerated spatial index search tree to obtain the anchor information corresponding to the document, comprises:
obtaining a target key matching the reference key from the document through searching each character in the document by the pregenerated spatial index search tree;
determining relative layout information of the reference key and a reference value of the reference key in a sample document;
taking the target key as an obtained anchor corresponding to the document, and the relative layout information as anchor information corresponding to the obtained anchor.

5. The method of claim 4, wherein there are reference anchors,
wherein, obtaining the target key matching the reference key from the document, comprises:
determining a matching path based on the correlation vectors, in which the matching path comprises at least two reference anchors;
traversing each reference anchor on the matching path based on the correlation vectors; and
obtaining a target key matching each of the reference keys by searching from the document.

6. The method of claim 4, wherein, determining the region information of the content to be extracted based on the anchor information, comprises:
determining candidate extraction templates, in which the candidate extraction templates each has corresponding candidate anchor information;
determining a candidate extraction template whose candidate anchor information matching the anchor information, and taking the determined candidate extraction template as a target extraction template; and
determining the region information of the content to be extracted based on the target extraction template.

7. The method of claim 6, wherein, determining the region information of the content to be extracted based on the target extraction template, comprises:
determining benchmark layout information in the target extraction template corresponding to the target key; and
determining the region information based on the benchmark layout information in combination with the relative layout information.

8. The method of claim 6, wherein, determining the candidate extraction template whose candidate anchor information matching the anchor information, comprises:
inputting the anchor information and the candidate anchor information to a pre-trained graph model, to obtain the determined candidate extraction template output by the graph model.

9. An electronic device, comprising:
at least one processor; and
a memory communicating with the at least one processor; wherein,
the memory is configured to store instructions executable by the at least one processor, and when the instructions are executed by the at least one processor, the at least one processor is cause to perform:
obtaining the document;
performing anchor search on the document to obtain anchor information corresponding to the document;
determining region information of content to be extracted based on the anchor information; and
extracting the content to be extracted from the document based on the region information.

10. The electronic device of claim 9, wherein, performing the anchor search on the document to obtain the anchor information corresponding to the document, comprises:
performing the anchor search on the document by a pregenerated spatial index search tree to obtain the anchor information corresponding to the document.

11. The electronic device of claim 10, wherein, the spatial index search tree comprises a plurality of nodes and a plurality of edges, in which, each of the plurality of nodes represents a character in a reference anchor, and each of the plurality of edges represents a correlation vector between characters corresponding to nodes connected by the corresponding edge.

12. The electronic device of claim 11, wherein, the reference anchor is a reference key,
wherein, performing the anchor search on the document by the pregenerated spatial index search tree to obtain the anchor information corresponding to the document, comprises:
obtaining a target key matching the reference key from the document through searching each character in the document by the pregenerated spatial index search tree;
determining relative layout information of the reference key and a reference value of the reference key in a sample document;
taking the target key as an obtained anchor corresponding to the document, and the relative layout information as anchor information corresponding to the obtained anchor.

13. The electronic device of claim 12, wherein there are reference anchors,
wherein, obtaining the target key matching the reference key from the document, comprises:
determining a matching path based on the correlation vectors, in which the matching path comprises at least two reference anchors;
traversing each reference anchor on the matching path based on the correlation vectors; and
obtaining a target key matching each of the reference keys by searching from the document.

14. The electronic device of claim 12, wherein, determining the region information of the content to be extracted based on the anchor information, comprises:
determining candidate extraction templates, in which the candidate extraction templates each has corresponding candidate anchor information;
determining a candidate extraction template whose candidate anchor information matching the anchor information, and taking the determined candidate extraction template as a target extraction template; and
determining the region information of the content to be extracted based on the target extraction template.

15. The electronic device of claim 14, wherein, determining the region information of the content to be extracted based on the target extraction template, comprises:
determining benchmark layout information in the target extraction template corresponding to the target key; and
determining the region information based on the benchmark layout information in combination with the relative layout information.

16. The electronic device of claim 14, wherein, determining the candidate extraction template whose candidate anchor information matching the anchor information, comprises:
inputting the anchor information and the candidate anchor information to a pre-trained graph model, to obtain the determined candidate extraction template output by the graph model.

17. A non-transitory computer-readable storage medium storing computer instructions, wherein the computer instructions are configured to cause a computer to execute a method for extracting content from a document comprising:
obtaining the document;
performing anchor search on the document to obtain anchor information corresponding to the document;
determining region information of content to be extracted based on the anchor information; and
extracting the content to be extracted from the document based on the region information.

18. The non-transitory computer-readable storage medium of claim 17, wherein, performing the anchor search on the document to obtain the anchor information corresponding to the document, comprises:
performing the anchor search on the document by a pregenerated spatial index search tree to obtain the anchor information corresponding to the document.

19. The non-transitory computer-readable storage medium of claim 18, wherein, the spatial index search tree comprises a plurality of nodes and a plurality of edges, in which, each of the plurality of nodes represents a character in a reference anchor, and each of the plurality of edges represents a correlation vector between characters corresponding to nodes connected by the corresponding edge.

20. The non-transitory computer-readable storage medium of claim 19, wherein, the reference anchor is a reference key,
wherein, performing the anchor search on the document by the pregenerated spatial index search tree to obtain the anchor information corresponding to the document, comprises:
obtaining a target key matching the reference key from the document through searching each character in the document by the pregenerated spatial index search tree;
determining relative layout information of the reference key and a reference value of the reference key in a sample document;
taking the target key as an obtained anchor corresponding to the document, and the relative layout information as anchor information corresponding to the obtained anchor.
